(19) United States
(12) Patent Application Publication
(10) Pub. No.: US 2005/0200290 A1
(43) Pub. Date: Sep. 15, 2005

(54) Illumination apparatus and image projection apparatus using the apparatus

(75) Inventor: Naoya Sugimoto, Hino-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/073,791

(22) Filed: Mar. 7, 2005

(30) Foreign Application Priority Data
Mar. 9, 2004 (JP) 2004-066035

(51) Int. Cl. H01J 7/24

(52) U.S. Cl. 315/118

(57) ABSTRACT

An illumination apparatus comprises a constant current power supply configured to be capable of supplying a constant current, a plurality of unit circuits each of which includes at least a switching member which is able to shut off a current supplied from the constant current power supply, and a control portion configured to control the plurality of switching members. The plurality of unit circuits is electrically connected to the constant current power supply in a matrix form. A predetermined number of unit circuits in the plurality of unit circuits further have at least one LED which is connected with the switching member in series in each current path which is set when the control portion controls the plurality of switching members.

### CROSS-REFERENCE TO RELATED APPLICATIONS

This application is based upon and claims the benefit of priority from prior Japanese Patent Application No. 2004-066035, filed Mar. 9, 2004, the entire contents of which are incorporated herein by reference.

### BACKGROUND OF THE INVENTION

1. Field of the Invention

The present invention relates to an illumination apparatus using an LED for a light source, and an image projection apparatus using such an illumination apparatus.

2. Description of the Related Art

In an illumination apparatus using LEDs as light sources, there is a method which causes a plurality of LEDs to simultaneously and sequentially emit a light in order to obtain a bright illumination light. In such a case, a power supply requires a current capacity corresponding to the number of the LEDs which are simultaneously turned on. Further, current circuits corresponding to the number of the LEDs which are simultaneously turned on are required. In this case, if a current value is high, an SW frequency of DC-DC cannot be set high due to a skin effect, and it is hard to increase an efficiency of DC-DC or reduce a size. Furthermore, a diameter of each wiring must be increased. Moreover, constant current circuits corresponding to the number of the LEDs which are simultaneously turned on require a space.

Thus, in an LED drive circuit which turns on the plurality of LEDs, a configuration in which a current value is determined to correspond to one LED is proposed in Jpn. Pat. Appln. KOKAI Publication No. 8-194439.

### BRIEF SUMMARY OF THE INVENTION

According to a first aspect of the present invention, there is provided an illumination apparatus comprising:
a constant current power supply configured to be capable of supplying a constant current;
a plurality of unit circuits each of which includes at least a switching member which is able to shut off a current supplied from the constant current power supply, the plurality of unit circuits being electrically connected to the constant current power supply in a matrix form; and
a control portion configured to control the plurality of switching members,
wherein a predetermined number of unit circuits in the plurality of unit circuits further have at least one LED which is connected with the switching member in series in each current path which is set when the control portion controls the plurality of switching members.

According to a second aspect of the present invention, there is provided an illumination apparatus comprising:
a constant current power supply configured to be capable of supplying a constant current;
a plurality of unit circuits each of which includes at least a switching member which is able to shut off a current supplied from the constant current power supply, the plurality of unit circuits forming each block when electrically connected in parallel with respect to the constant current power supply, and the plurality of blocks obtained by connecting the plurality of unit circuits in parallel being electrically connected in series; and
a control portion configured to control the plurality of switching members,
wherein a predetermined number of unit circuits in the plurality of units circuits further have at least one LED which is connected with the switching member in series in each current path which is set when the control portion controls the plurality of switching members.

According to a third aspect of the present invention, there is provided an image projection apparatus which projects an image according to image information input thereto, comprising:
an illumination apparatus including:
a constant current power supply configured to be capable of supplying a constant current;
a plurality of unit circuits each of which includes at least a switching member which is able to shut off a current supplied from the constant current power supply, the plurality of unit circuits being electrically connected to the constant current power supply in a matrix form; and
a control portion configured to control the plurality of switching members, a predetermined number of unit circuits in the plurality of unit circuits further having at least one LED which is connected with the switching member in series in each current path which is set when the control portion controls the plurality of switching members;
a space modulation element configured to perform modulation in accordance with the input image information;
an illumination optical system configured to illuminate the space modulation element by leading illumination light exiting from LEDs of the illumination apparatus; and
a projection optical system configured to project an image modulated by the space modulation element which is illuminated by the illumination optical system,
wherein a control portion of the illumination apparatus is configured to sequentially turn on the plurality of LEDs in time series, and
the illumination optical system has a light leading member which is synchronized with a lighting timing of the plurality of LEDs and relatively moves the plurality of LEDs, thereby leading illuminating light exiting from the LEDs which sequentially turned on in time series to the space modulation element.

According to a fourth aspect of the present invention, there is provided an image projection apparatus which projects an image according to image information input thereto, comprising:
an illumination apparatus including:
a constant current power supply configured to be capable of supplying a constant current;
a plurality of unit circuits each of which includes at least a switching member which is able to shut off a current supplied from the constant current power supply, the plurality of unit circuits forming each block when electrically connected in parallel with respect to the constant current power supply, and the plurality of blocks obtained by connecting the plurality of unit circuits in parallel being electrically connected in series; and
a control portion configured to control the plurality of switching members, a predetermined number of unit circuits in the plurality of units circuits further having at least one LED which is connected with the switching member in series in each current path which is set when the control portion controls the plurality of switching members;
a space modulation element configured to perform modulation in accordance with the input image information;
an illumination optical system configured to illuminate the space modulation element by leading illumination light exiting from LEDs of the illumination apparatus; and
a projection optical system configured to project an image modulated by the space modulation element which is illuminated by the illumination optical system,
wherein a control portion of the illumination apparatus is configured to sequentially turn on the plurality of LEDs in time series, and
the illumination optical system has a light leading member which is synchronized with a lighting timing of the plurality of LEDs and relatively moves the plurality of LEDs, thereby leading illuminating light exiting from the LEDs which sequentially turned on in time series to the space modulation element.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an arrangement of LEDs and an arrangement position of an L-shaped light leading rod in an illumination apparatus according to a first embodiment of the present invention;

FIG. 2 is a view showing the L-shaped light leading rod;

FIG. 3 is a view showing a relationship between a lighting state of the LEDs and a rotation position of the L-shaped light leading rod in the first embodiment;

FIG. 4 is a view showing a circuit configuration of a conventional LED drive portion;

FIG. 5 is a view showing a circuit configuration of an LED drive portion in the illumination apparatus according to the first embodiment;

FIG. 6 is a view sowing a relationship between an LED lighting order and an FET operation in the first embodiment;

FIG. 7 is a view showing an FET control timing chart;

FIG. 8 is a view illustrating a current path when the FET is switched;

FIG. 9 is a view showing a configuration of a light source control circuit in the illumination apparatus according to the first embodiment;

FIG. 10 is a view showing a circuit configuration of an LED drive portion in an illumination apparatus according to a second embodiment of the present invention;

FIG. 11 is a an I-V characteristic view illustrating irregularities in I-V characteristics of the LEDs;

FIG. 12 is a waveform chart of a voltage and a current illustrating an overcurrent generated when switching a lighting state in the second embodiment;

FIG. 13 is a view showing another circuit configuration of the LED drive portion in the illumination apparatus in the second embodiment;

FIG. 14 is a view illustrating a function of a current limiting circuit in the configuration depicted in FIG. 13;

FIG. 15 is a view showing a configuration of an image projection apparatus according to a third embodiment of the present invention when LCDs with a color filter are used as space modulation elements;

FIG. 16 is a view showing a light beam shape conversion element;

FIG. 17 is a view showing a configuration of the image projection apparatus according to the third embodiment of the present invention when a DMD is used as a space modulation element;

FIG. 18 is a view showing a relationship between a lighting state of LEDs and a rotation position of an L-shaped light leading rod in the image projection apparatus depicted in FIG. 17;

FIG. 19 is a view showing a configuration of a light source control circuit in the image projection apparatus depicted in FIG. 17;

FIG. 20 is a view showing a control timing or a voltage value and a current value in the image projection apparatus depicted in FIG. 17;

FIG. 21 is a view showing a configuration of an image projection apparatus according to a third embodiment of the present invention when three LCDs with no color filter are used as space modulation elements;

FIG. 22 is a view showing an arrangement of LEDs in an illumination apparatus according to a fourth embodiment of the present invention;

FIG. 23 is a view showing a circuit configuration of an LED drive portion;

FIG. 24 is a view showing a relationship between an LED lighting order and an FET operation;

FIG. 25 is a view showing an FET control timing chart;

FIG. 26 is a view showing a transition of a lighting state of the LEDs in the configuration depicted in FIG. 23;

FIG. 27 is a view showing another circuit configuration of the LED drive portion in the illumination apparatus according to the fourth embodiment;

FIG. 28 is a view showing a relationship between an LED lighting order and an FET operation;

FIG. 29 is a view showing an FET control timing chart;

FIG. 30 is a view showing a transition of a lighting state of LEDs in the configuration depicted in FIG. 27;

FIG. 31 is a view showing a circuit configuration of an LED drive portion in an illumination apparatus according to a fifth embodiment of the present invention;

FIG. 32 is a view showing an arrangement of LEDs in the fifth embodiment;

FIG. 33 is a view showing an FET control timing chart in the fifth embodiment; and

FIG. 34 is a view showing a relationship between an LED lighting state and a rotation position of an L-shaped light leading rod in the fifth embodiment.

### DETAILED DESCRIPTION OF THE INVENTION

The best modes for embodying the present invention will now be described hereinafter with reference to the accompanying drawings.

### First Embodiment

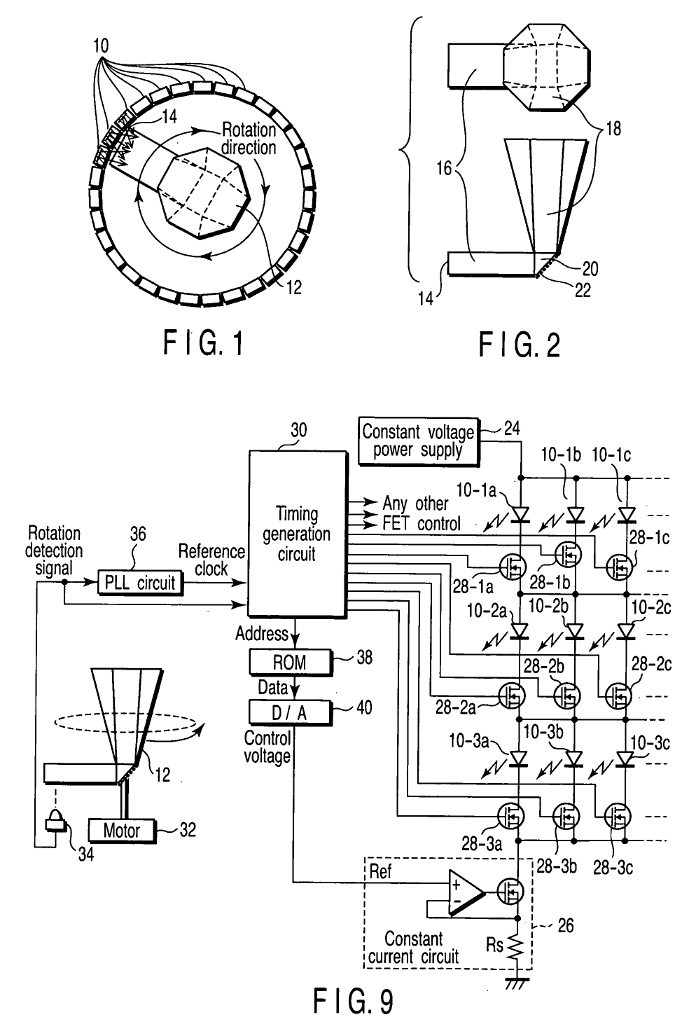

In an illumination apparatus according to a first embodiment of the present invention, as shown in FIG. 1, a plurality of LEDs 10 as light sources are arranged to be close to each other on a circumference. In this case, the respective LEDs 10 are arranged in such a manner that light beams are emitted in the same direction vertical to a surface on which the LEDs are arranged. An L-shaped light leading rod 12 as a light leading member is arranged in the direction along which light beams from these LEDs 10 are emitted. This L-shaped light leading rod 12 is fixed to a non-illustrated rod holder and rotated with a center of a circle on which the LEDs 10 are arranged as a rotation axis at a fixed rotational speed by a non-illustrated motor. As a result, a light fetching opening 14 as a fetching portion of this L-shaped light leading rod 12 can fetch light beams from corresponding LEDs 10 at opposing positions on the circumference where the LEDs 10 are arranged.

In this example, as shown in FIG. 2, the L-shaped light leading rod 12 comprises a parallel rod 16 which has a rectangular shape and whose entire surface is a mirror surface, a shape conversion tapered rod 18 which has a square incidence end and a regular octagonal projection end, and a reflection prism 20 with a high refraction factor. That is, the L-shaped light leading rod 12 is formed by bonding the parallel rod 16 and the shape conversion tapered rod 18 with the reflection prism 20 having a higher refraction factor formed of a material with a higher refraction factor than those of the parallel rod 16 and the shape conversion tapered rod 18 being sandwiched therebetween. In such an L-shaped light leading rod 12, a light which has entered from the light fetching opening 14 of the parallel rod 16 enters the reflection prism 20 with a high refraction factor while repeating total reflection on inner side surfaces of the parallel rod 16. The light which has entered the reflection prism 20 with a high refraction factor is reflected on a 45° reflection surface of the reflection prism 20 with a high refraction factor having a reflection coat 22 applied thereto, and then enters the square incidence end of the shape conversion tapered rod 18. The light which has entered the shape conversion tapered rod 18 undergoes an effect of reducing a light ray angle with respect to a central axis of the shape conversion tapered rod 18 by total reflection on the inner side surfaces of the shape conversion tapered rod 18 which expands toward its projection end. Then, the light exits from the projection end of the shape conversion tapered rod 18 with its light ray spreading angle reduced.

Since a refraction factor of the reflection prism 20 with a high refraction is set higher than that of the parallel rod 16 and the shape conversion tapered rod 18, it is possible to utilize total reflection characteristics for a light ray which enters at a deep angle due to a refraction factor difference on a bonded surface of the reflection prism 20 with a high refraction factor. As a result, it is possible to avoid generation of a light ray which enters the shape conversion tapered rod 18 without being reflected on the reflection surface of the reflection prism 20 with a high refraction factor and leaks to the outside from side surfaces of the shape conversion tapered rod 18 and a light ray which is reflected on the reflection surface of the reflection prism 20 with a high refraction factor, returns to the parallel rod 16 and leaks to the outside from the side surfaces of the parallel rod 16.

As the reflection coat 22 of the reflection prism 20 with a high refraction factor, it is possible to use, e.g., a dielectric coat with respect to a specific wavelength, and a metal film or a high reflection coat in which a metal film is combined with a dielectric material with respect to a light in a board band.

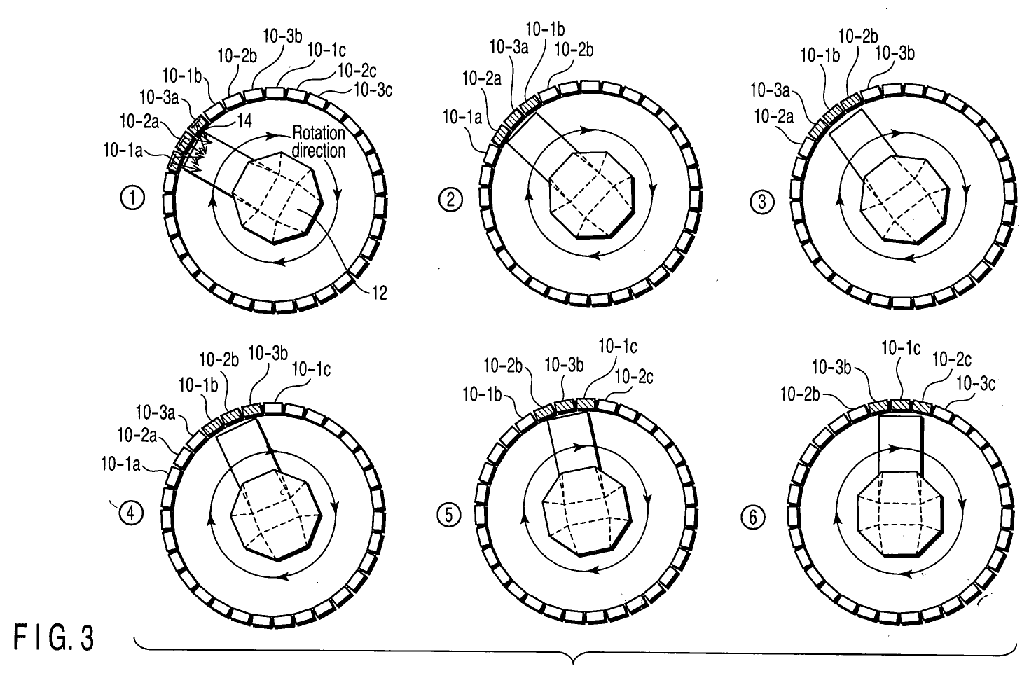

In the illumination apparatus according to this embodiment, a predetermined number (three in this example) of LEDs of the plurality of LEDs 10 arranged on the circumference are simultaneously and sequentially caused to emit pulse light as shown in \mathring{1} to \mathring{6} in FIG. 3. At this time, the L-shaped light leading rod 12 is rotated in accordance with this light emission in such a manner that the light fetching opening 14 of the L-shaped light leading rod 12 faces the light emitting LEDs 10. By fetching the light from the light emitting LEDs 10 in this manner, bright light obtained by pulse light emission of the LEDs 10 can be constantly taken out from the L-shaped light leading rod 12.

That is, with a timing shown in \mathring{1} of FIG. 3, the LEDs 10-1a, 10-2a and 10-3a are turned on, and light beams from these LEDs 10-1a, 10-2a and 10-3a are fetched in the light fetching opening 14 of the L-shaped light leading rod 12. With a next timing shown in \mathring{2}, the LED 10-1a is turned off, and the LEDs 10-2a and 10-3a and an LED 10-1b are turned on. Then, light beams from these LEDs 10-2a, 10-3a and the LED 10-1b are fetched in the light fetching opening 14 of the L-shaped light leading rod 12 which has rotated to a position corresponding to the LEDs 10-2a and 10-3a and the LED 10-1b. With a next timing shown in \mathring{3}, the LED 10-2a is turned off, and the LEDs 10-3a and 10-1b and an LED 10-2b are turned on. Then, light beams from these LEDs 10-3a and 10-1b and the LED 10-2b are fetched in the light fetching opening 14 of the L-shaped light leading rod 12 which has rotated to a position corresponding to the LEDs 10-3a and 10-1b and the LED 10-2b. Thereafter, likewise, the LEDs to be turned on are shifted one by one, and the L-shaped light leading rod 12 rotates in accordance with this shifting.

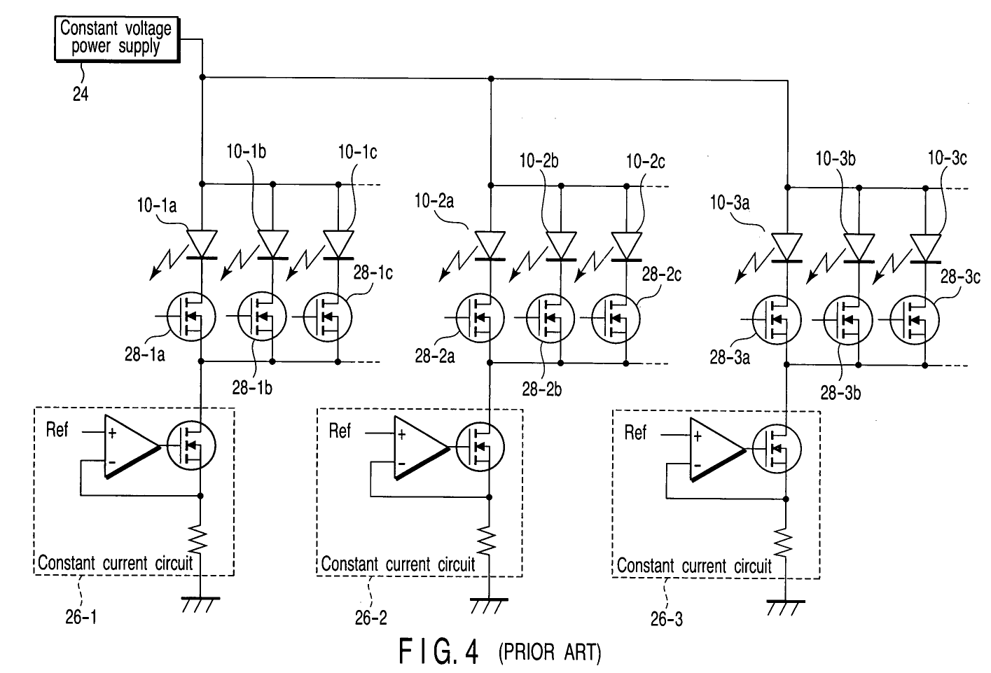

It is to be noted that driving using a constant current is good in order to stabilize a light quantity of each LED. In cases where a plurality of LEDs are sequentially turned on like this embodiment, circuit such as shown in FIG. 4 have been conventionally used. That is, respective LEDs 10-1a, 10-1b, 10-1c, . . . , 10-2a, 10-2b, 10-2c, . . . , 10-3a, 10-3b, 10-3c, . . . are connected between a constant voltage power supply 24 and the constant current circuits 26-1, 26-2 and 26-3 through FETs 28-1a, 28-1b, 28-1c, . . . , 28-2a, 28-2b, 28-3c, 28-3a, 28-3b, 28-3c, . . . . In this case, the LEDs 10-a, 10-1b, 10-1c, . . . which are not simultaneously turned on (and corresponding FETs 28-1a, 28-1b, 28-1c, . . . ) are connected to the constant current circuit 26-1. Likewise, the LEDs 10-2a, 10-2b, 10-2c, . . . (and the corresponding FETs 28-2a, 28-2b, 28-2c, . . . ) are connected with the constant current circuit 26-2, and the LEDs 10-3a, 10-3b, 10-3c, . . . (and the corresponding FETs 28-3a, 28-3b, 28-3c, . . . ) are connected with the constant current circuit 26-3.

Therefore, with the timing shown in \mathring{1} in FIG. 3, the FET 28-1a, 28-2a and 28-3a are turned on by controlling of a non-illustrated control portion, and the LEDs 10-a, 10-1b and 10-3a emit light. Likewise, with the timing shown in \mathring{2} in FIG. 3, the FETs 28-2a, 28-3a and 28-3b are turned on, and the LEDs 10-2a, 10-3a and 10-3b emit light.

When such a circuit configuration is adopted, the constant voltage power supply 24 requires a current capacity corresponding to the number of LEDs 10 which are simultaneously turned on (three in this example), and the constant current circuits 26-1, 26-2 and 26-3 also require a current capacity corresponding to the number of LEDs 10 which are simultaneously turned on (three in this example).

In order to solve such a problem, such a technique as disclosed in Jpn. Pat. Appln. KOKAI Publication No. 8-194439 is proposed. According to an apparatus disclosed in this publication, in an LED drive circuit which turns on a plurality of LEDs, a current value can be determined to correspond to one LED. However, a current constantly flows through switching members (transistors) which are connected with LEDs which are not turned on in parallel, and losses are high. When FETs are used for the switching members in order to suppress losses as much as possible, a control voltage Vg for the FETs must be changed depending on a position at which the LEDs are turned on, and a Vg voltage switching circuit is required.

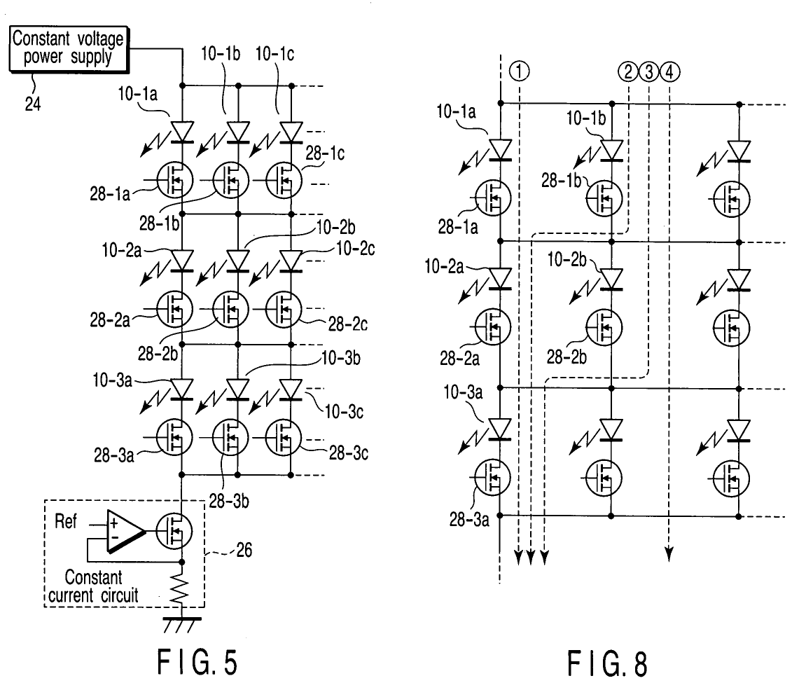

Thus, in this embodiment, as shown in FIG. 5, a plurality of unit circuits each including an LED 10 and an FET 28 are electrically connected between the constant voltage power supply 24 and the constant current circuit 26 in a matrix form so that the number of constant current circuit 26 is one. That is, a unit circuit including an LED 10-1a and an FET 28-1a, a unit circuit including an LED 10-1b and an FET 28-1b, a unit circuit including an LED 10-1c and an FET 28-1c, . . . are electrically connected in parallel, thereby forming a block. Further, a unit circuit including an LED 10-2a and an FET 28-2a, a unit circuit including an LED 10-2b and an FET 28-2b, a unit circuit including an LED 10-2c and an FET 28-2c, . . . are electrically connected in parallel, thereby forming a block. Likewise, a unit circuit including an LED 10-3a and an FET 28-3a, a unit circuit including an LED 10-3b and an FET 28-3b, a unit circuit including an LED 10-3c and an FET 28-3c, . . . are electrically connected in parallel, thereby forming a block. Furthermore, these blocks are electrically connected in series between the constant voltage power supply 24 and the constant current circuit 26.

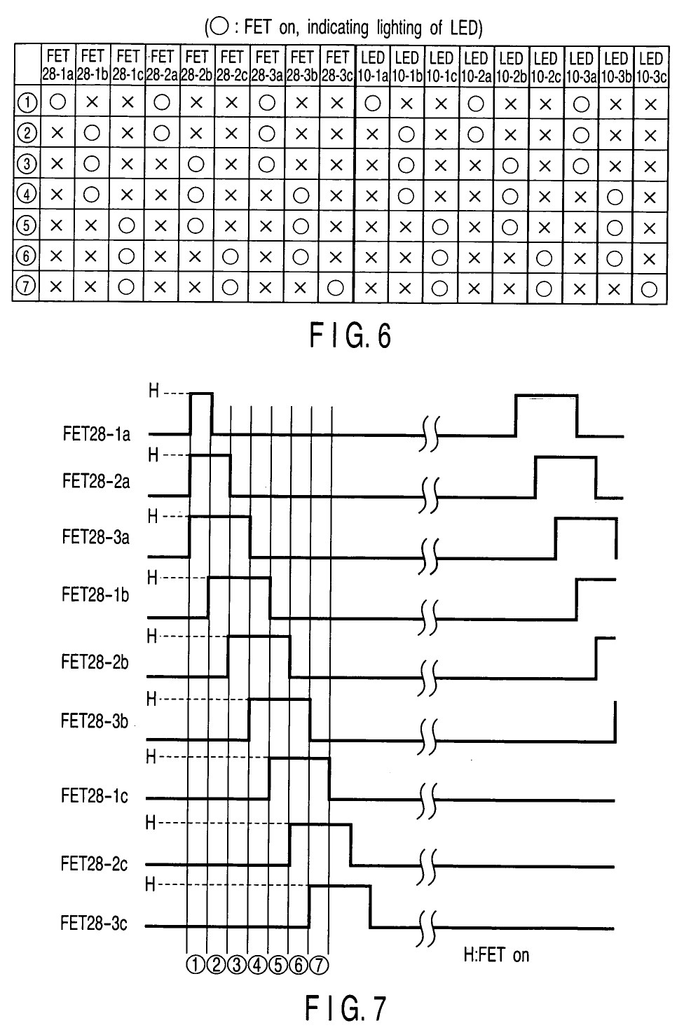

In such a circuit configuration, as shown in FIGS. 6 and 7, a predetermined number (three in this example) of LEDs can be simultaneously and sequentially subjected to pulse light emission as shown in FIG. 3 by selecting a switching state of each FET 28. It is to be noted that FIG. 6 shows a relationship between an LED lighting order and an FET operation, a circle (◯) indicates an ON state of an FET or a lighted state of an LED and a cross (X) indicates an OFF state of an FET or a light-out state of an LED. Moreover, FIG. 7 is a view showing an FET control timing chart, and a horizontal axis of each waveform indicates a time and a vertical axis indicates a control voltage (an FET is turned on in case of H), respectively.

Specifically, for example, in a period indicated by \mathring{1} in FIGS. 6 and 7, the FETs 28-1a, 28-2a and 28-3a are turned on, and any other FETs are turned off. In such a state, as likewise indicated by \mathring{1} in FIG. 8, a current path of the LED 10-1a, the FET 28-1a, the LED 10-2a, the FET 28-2a, the LED 10-3a and the FET 28-3a is formed, and the LEDs 10-1a, 10-2a and the LED 10-3a are turned on. That is, a state likewise indicated by \mathring{1} in FIG. 3 can be obtained.

In a period indicated by \mathring{2} in FIGS. 6 and 7, the FETs 28-1b, 28-2a and 28-3a are turned on, and any other FETs are turned off. In such a state, as likewise indicated by \mathring{2} in FIG. 8, a current path of the LED 10-1b, the FET 28-1b, the LED 10-2a, the FET 28-2a, the LED 10-3a and the FET 28-3a is formed, and the LED 10-1b, 10-2a and the LED 10-3a are turned on. That is, a state likewise indicated by \mathring{2} in FIG. 3 can be obtained.

Additionally, in a period indicated by \mathring{3} in FIGS. 6 and 7, the FETs 20-1b, 28-2b and 28-3a are turned on, and any other FETs are turned off. In such a state, as likewise indicated by \mathring{3} in FIG. 8, a current path of the LED 10-1b, the FET 28-1b, the LED 10-2b, the FET 28-2b, the LED 10-3a and the FET 28-3a is formed, and the LEDs 10-1b and 10-2b and the LED 10-3a are turned on. That is, a state likewise indicated by \mathring{3} in FIG. 3 can be obtained.

Thereafter, in the same manner, the LEDs can be simultaneously and sequentially subjected to pulse light emission by switching the ON state of the respective FETs 28.

A light source control circuit including the LED drive portion having such a circuit configuration has, as shown in FIG. 9, a timing generation circuit 30, a motor 32, a photodetector 34, a PLL circuit 36, an ROM 38 and a D/A converter 40 in addition to the LED drive portion having the above-described configuration. In this example, the timing generation circuit 30 functions as the control portion which controls each FET 28 of the LED drive portion. The motor 32 rotates the L-shaped light leading rod 12 at a fixed speed. The photodetector 34 outputs a rotation detection signal according to rotation of the L-shaped light leading rod 12 by detecting a non-illustrated rotation detection mark given to the rod holder which holds the L-shaped light leading rod 12. The PLL circuit 36 generates a reference clock based on the rotation detection signal from the photodetector 34. The ROM 38 stores data of a control voltage supplied to the constant current circuit 26 of the LED drive portion. Further, the D/A converter 40 converts data read from the ROM 38 into an actual control voltage.

In such a configuration, the rotation detection signal output from the photodetector 34 is input to the PLL circuit 36 and the timing generation circuit 30. The PLL circuit 36 generates a reference clock synchronized with rotation of the L-shaped light leading rod 12 by using the input rotation detection signal, and supplies the generated reference clock to the timing generation circuit 30. The timing generation circuit 30 stores a table which is used for an ON/OFF control over the FETs such as shown in FIG. 6. Therefore, the respective FETs 28 are subjected to the ON/OFF switching control based on the table and the input reference clock and rotation detection signal in such a manner that a predetermined number of the LEDs 10 at positions facing the light fetching opening 14 of the L-shaped light leading rod 12 are caused to emit light.

At this time, a drive current which is selectively supplied to the predetermined number of the LEDs 10 based on the ON state of each FET 28 is controlled to have a predetermined value and fed by the constant current circuit 26. That is, the timing generation circuit 30 supplies an address indicative of an area of control voltage data to the ROM 38, outputs this data from the ROM 38 to the D/A converter 40, and supplies a control voltage Ref to the constant current circuit 26.

It is to be noted that there may be a case where LEDs having different characteristics such as a luminous color may be mixed as the plurality of LEDs 10. In such a case, data of different control voltages according to the LEDs 10 of respective colors is stored in the ROM 38 in advance. Furthermore, it is good enough that the timing generation circuit 30 is used to set different addresses in the ROM 38 in accordance with the LEDs 10 of respective colors.

### Second Embodiment

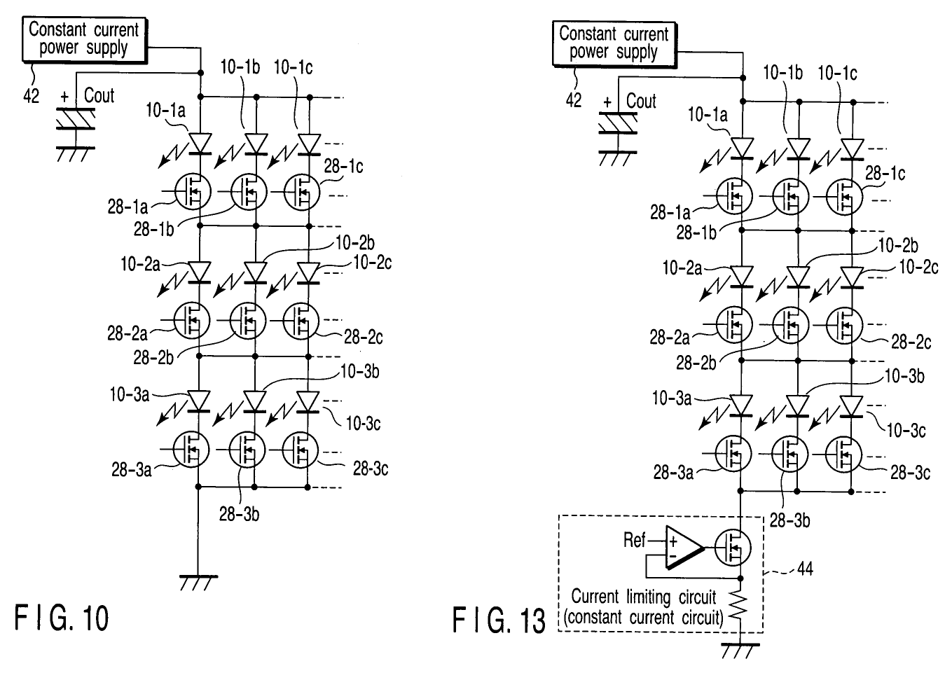

In the first embodiment, as shown in FIG. 5, the constant voltage power supply 24, the unit circuits (the FETs 28) arranged in a matrix form and the constant current circuit 26 form the LED drive portion. As shown in FIG. 10, the constant current circuit 26 may be eliminated by substituting a constant current power supply 42 for the constant voltage power supply 24.

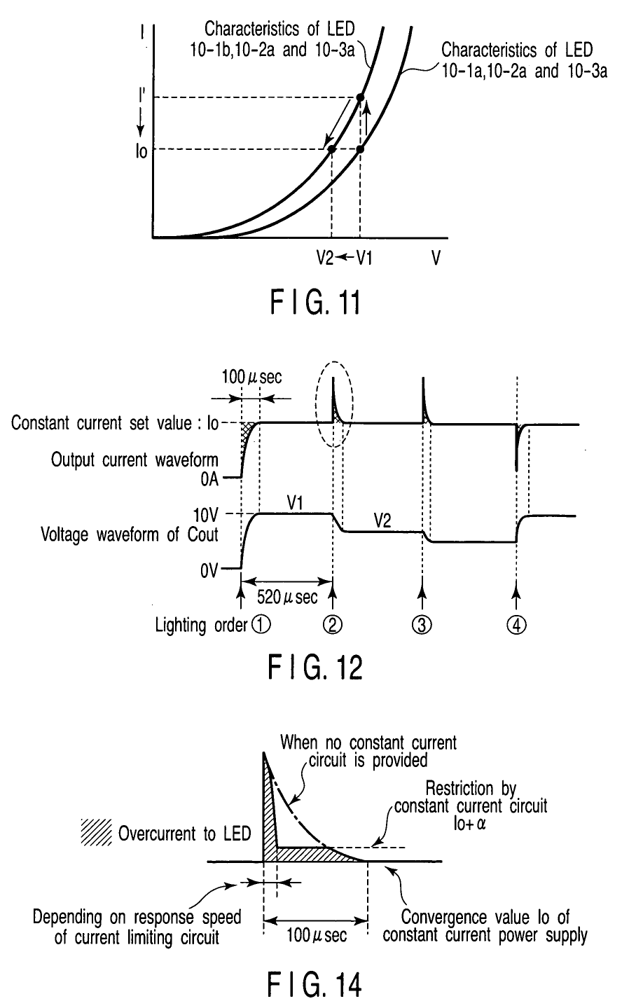

However, in the LEDs 10, solid-state irregularities are large in a current (I) flowing through the LEDs with respect to a forward applied voltage (Vf) of the LEDs. Therefore, as shown in FIG. 11, characteristics of the current with respect to the forward applied voltage (I-V characteristics) when the LEDs 10-1a, 10-2a and 10-3a are turned on do not match with I-V characteristics when the LEDs 10-1b, 10-2a and 10-3a are turned on. Therefore, at a moment when a lighting state indicated by \mathring{1} in FIG. 6 is switched to a lighting state indicated by \mathring{2} in the same figure, as shown in FIG. 12, an overcurrent is generated. That is, in the lighting state indicated by \mathring{1}, a current having a constant current set value Io flows with respect to a forward applied voltage which is a given voltage V1. When the voltage V1 is applied to the LEDs 10-1b, 10-2a and 10-3a at a moment switched to the lighting state indicated by \mathring{2}, a current I′ which is larger than the constant current set value Io flows through these LEDs. Thereafter, a control is performed by the constant current power supply 42, the applied voltage is automatically lowered to V2, and the current is changed to the constant current set value Io. This change time is dependent on an intensity of an output capacitor Cout of the constant current power supply 42 and an impedance of a load.

Since the overcurrent is dependent on an intensity of the output capacitor Cout of the constant current power supply 42 in this manner, a majority of the overcurrent can be avoided as shown in FIG. 14 by providing a current limiting circuit 44 as shown in FIG. 13 and setting its current limit value to Io+α which is slightly larger than the set value Io of the constant current power supply 42. It is to be noted that FIG. 14 corresponds to a part surrounded with an ellipse of a broken line in FIG. 12.

As the current limiting circuit 44, a constant current circuit which is the same as the constant current circuit 26 can be used. Therefore, the circuit shown in FIG. 13 resembles the circuit in the first embodiment (FIG. 5), but heat generation in the current limiting circuit 44 can be suppressed low.

### Third Embodiment

An example where the illumination apparatus explained in the first embodiment or the second embodiment is applied to an image projection apparatus will now be described as a third embodiment according to the present invention.

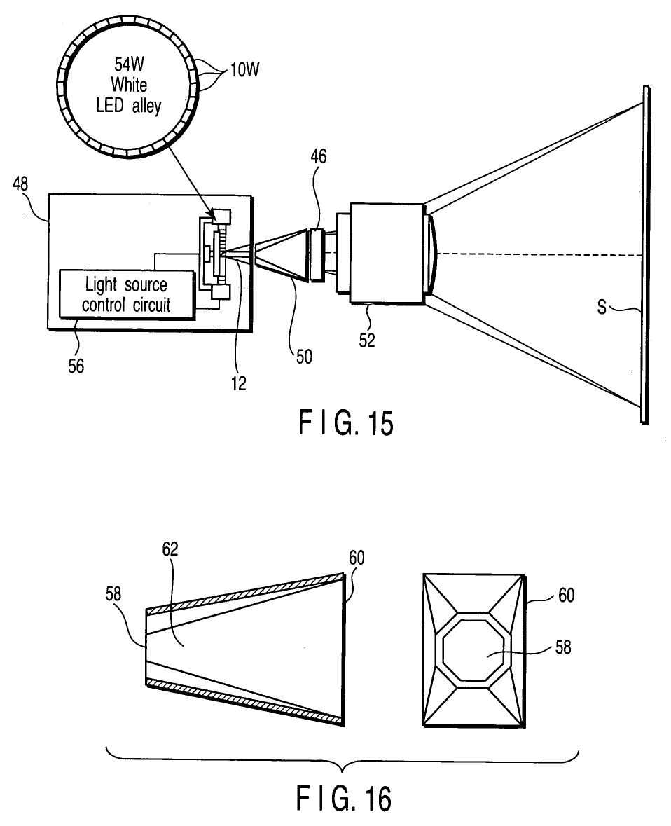

FIG. 15 shows an image projection apparatus using an LCD (a transmission type liquid crystal panel) 46 with a color filter as a space modulation element which performs modulation in accordance with input image information. That is, this image projection apparatus comprises an LED illumination unit 48 which corresponds to the illumination apparatus described in the first embodiment or the second embodiment, a light beam shape conversion element 50, the LCD 46 with a color filter and a projection lens 52. The projection lens 52 is a projection optical system which is illuminated with an illumination light whose light beam shape has been converted by the light beam shape conversion element 50 and projects an image modulated by the LCD 46 with a color filter on a screen S.

In this case, since the LCD 46 with a color filter is used as the space modulation element, a white LED array 54W having white LEDs 10W arranged on a circumference is used in the LED illumination unit 48. A predetermined number of the white LEDs 10w of this white LED array 54W are simultaneously and sequentially subjected to pulse light emission by a light source control circuit 56 described in the first embodiment. Furthermore, the L-shaped light leading rod 12 is rotated in such a manner that the light fetching opening 14 faces the lighted white LEDs 10W, and fetches white illumination light emitted by the white LEDs 10W.

The thus fetched white illumination light exits from a projection end of the shape conversion tapered rod 18 of the L-shaped light leading rod 12 with its light ray spreading angle being reduced. As described above, the projection end of the shape conversion tapered rod 18 has a regular octagonal shape, and hence the white illumination light exiting from this projection end also has a regular octagonal shape as seen from a surface vertical to its axial direction. On the other hand, the LCD 46 with a color filter has a rectangular shape. Thus, in this embodiment, a light beam shape conversion element 50 which forms an illumination optical system together with the L-shaped light leading rod 12 is arranged between the projection end of the shape conversion tapered rod 18 of the L-shaped light leading rod 12 and the LCD 46 with a color filter so that a shape of a light beam is converted from an octagonal shape into a rectangular shape. This light beam shape conversion element 50 is, as shown in FIG. 16, a hollow member which has an incidence end 58 with a regular octagonal shape and a projection end 60 with a rectangular shape and expands from the incidence end 58 toward the projection end 60. A reflection coat 62 is applied on its inner surface. It is to be noted that the light beam shape conversion element 50 may be formed as a solid rod member which performs total reflection on its inner side surfaces like the shape conversion tapered rod 18 of the L-shaped light leading rod 12 in place of such a hollow member.

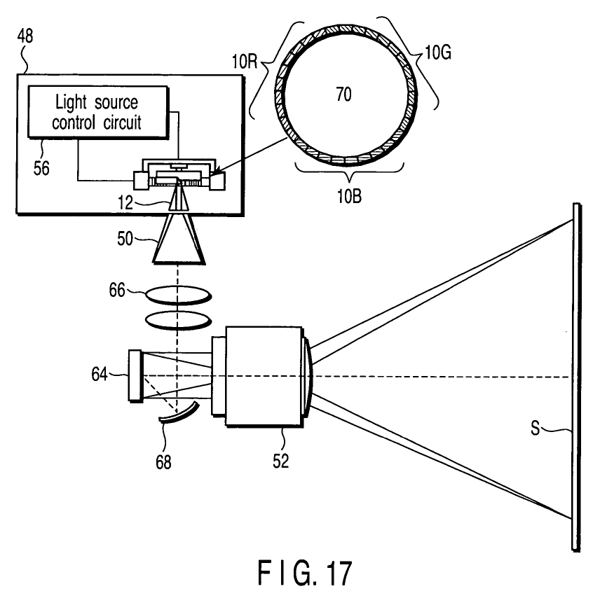

FIG. 17 shows a configuration of an image projection apparatus which employs as a space modulation element a reflection type display element (e.g., a DMD (: a registered trademark of Texas Instruments, Inc. in U.S.A.) 64 or the like) using a mirror for each pixel as a space. It is to be noted that the detail of the DMD 64 is disclosed in, e.g., U.S. 2002/0024637 A1 or U.S. 2002/0180939 A1, and hence its explanation will be eliminated here.

The image projection apparatus in this example comprises an LED illumination unit 48, a light beam shape conversion element 50, an illumination lens 66 which illuminates the DMD 64 with a light exiting from the light beam shape conversion element 50, an illumination mirror 68 which reflects an illumination light from the illumination lens 66 toward the DMD 64, the DMD 64 and a projection lens 52. Furthermore, in the LED illumination unit 48 is used an LED array 70 in which a predetermined number of each of red LEDs 10R, green LEDs 10G and blue LEDs 10B are arranged on a circumference. That is, the LED array 70 is divided into three areas of R, G and B, and the DMD 64 displays images corresponding to R, G and B in the surface order. Therefore, light emission of the LEDs 10R, 10G and 10B is synchronized with switching of images.

It is to be noted that a red color, a green color and a blue color are indicated by using different hatchings, and the hatchings do not represent a cross section (this is also applied to any other drawings which will be described below). Moreover, each ratio of LEDs of R, G and B is 1/3, this ratio can be of course changed. That is, if there are LEDs of a given color having a smaller light emission quantity than other colors, the number of LEDs of this color may be increased, and the number of LEDs of any other colors may be decreased so that light quantities of the respective colors can be equalized.

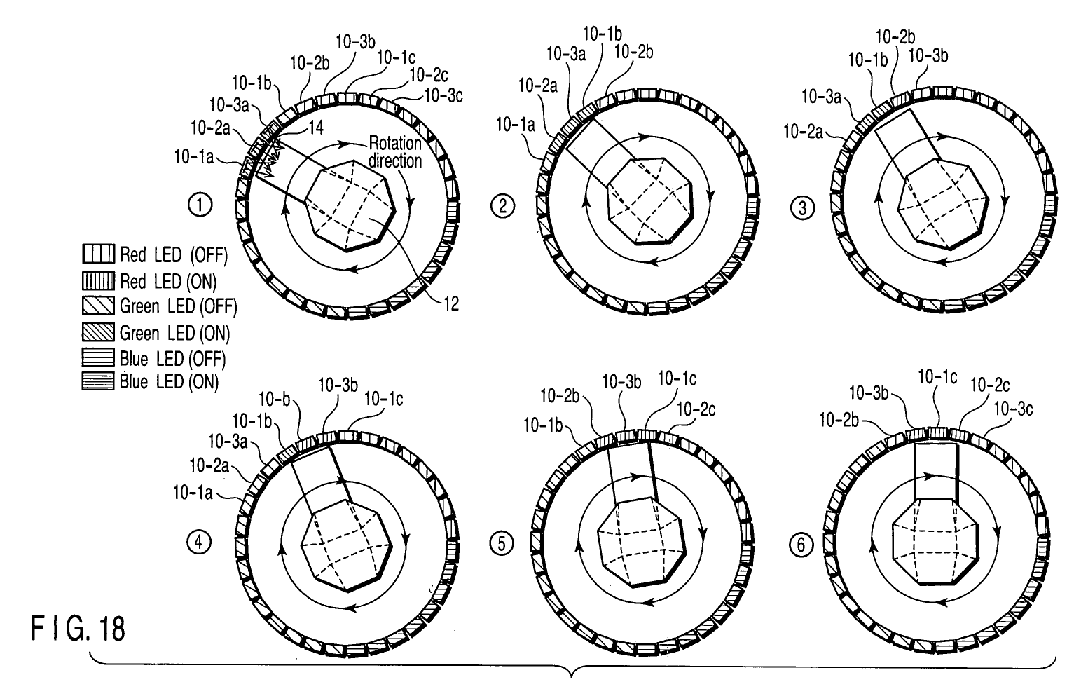

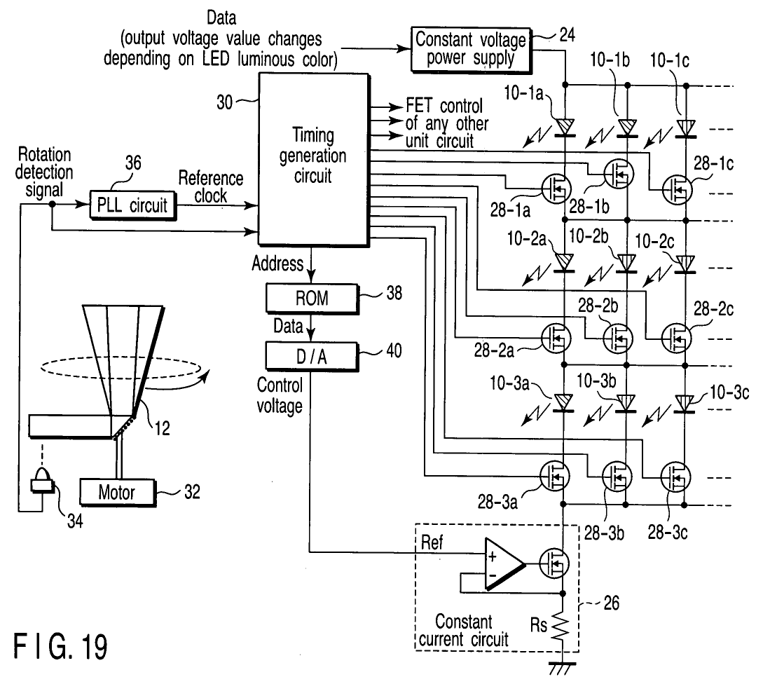

FIG. 18 is a view showing an arrangement of the LED array 70 when such a DMD 64 is used, and FIG. 19 is a view showing a configuration of a light source control circuit 56. In these drawings, luminous colors of the LEDs are just changed from those in FIGS. 3 and 9 described in conjunction with the first embodiment. That is, the FET control timing or the light emission order is the same as those shown in FIGS. 6 and 7.

However, since the forward applied voltage (Vf) of the LEDs varies depending on each luminous color and heat generation in the constant current circuit 26 is increased, the current value must be also changed. Therefore, in the configuration shown in FIG. 19, an output from the constant voltage power supply 24 is variable. Additionally, sets of control voltage data according to LED luminous colors are stored in different areas in the ROM 38 in advance so that the control current value in the constant current circuit 26 becomes also variable, and the timing generation circuit 30 changes addressing in the ROM 38 in accordance with each luminous color. Alternatively, control voltage data may be appropriately rewritten depending on each LED luminous color by using, e.g., a rewritable EEPROM in place of the ROM 38.

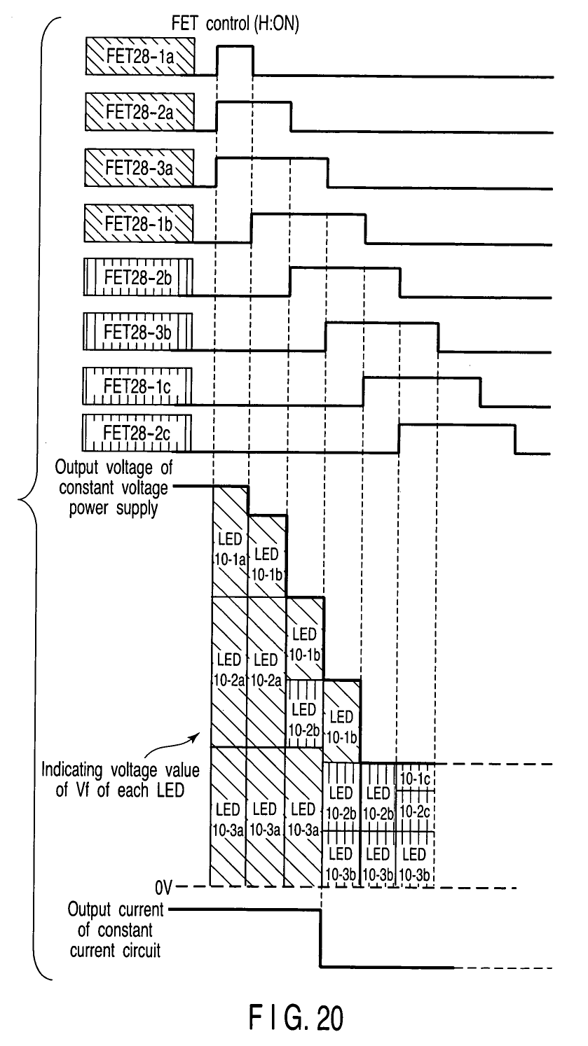

FIG. 20 is a view showing a control timing, a voltage value and a current value in this case. A timing chart in an upper section of the drawing shows a control over the FETs 28, and a middle section shows an output voltage from the constant voltage power supply 24. This voltage is changed every time the LEDs are switched because Vf of the LEDs connected in series differs due to solid-state irregularities. Further, a lower section in the drawing shows a change in a set current of the constant current circuit 26. Since a necessary current value differs in each light emitting color LED, the current value is reduced when the red LED emits a light.

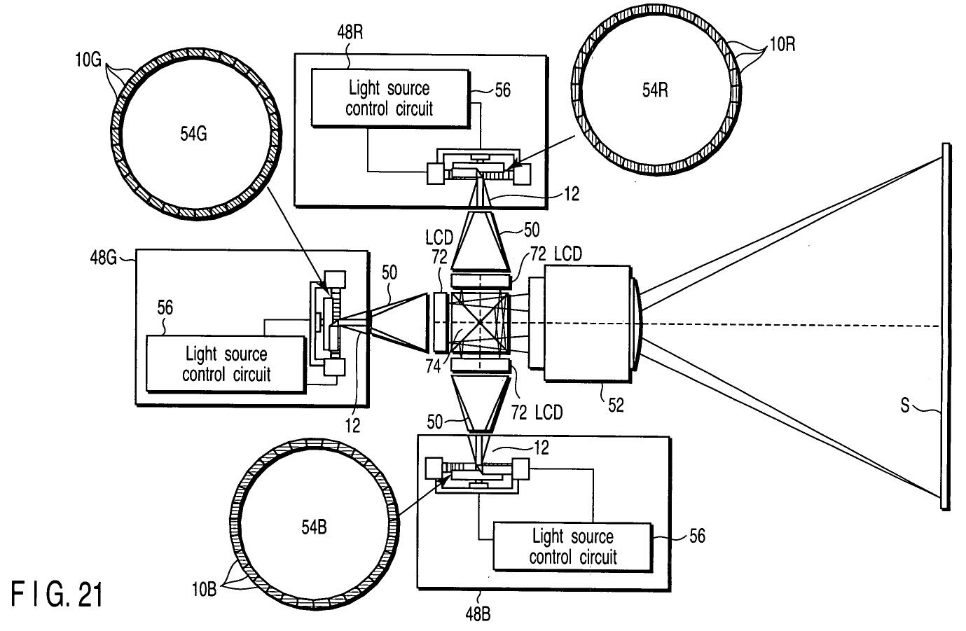

FIG. 21 shows a configuration of an image projection apparatus when three LCDs 72 having no color filter are used as space modulation elements. This image projection apparatus uses three LED illumination units having a monochrome LED array such as shown in FIG. 15 (e.g., an LED illumination unit 48R having a red LED array 54R, an LED illumination unit 48G having a green LED array 54G, and an LED illumination unit 48B having a blue LED array 54B). Furthermore, images modulated by the three LCDs 72 illuminated with illumination light of respective colors are combined with each other by an X prism 74 so that a combined image enters a projection lens 52.

### Fourth Embodiment

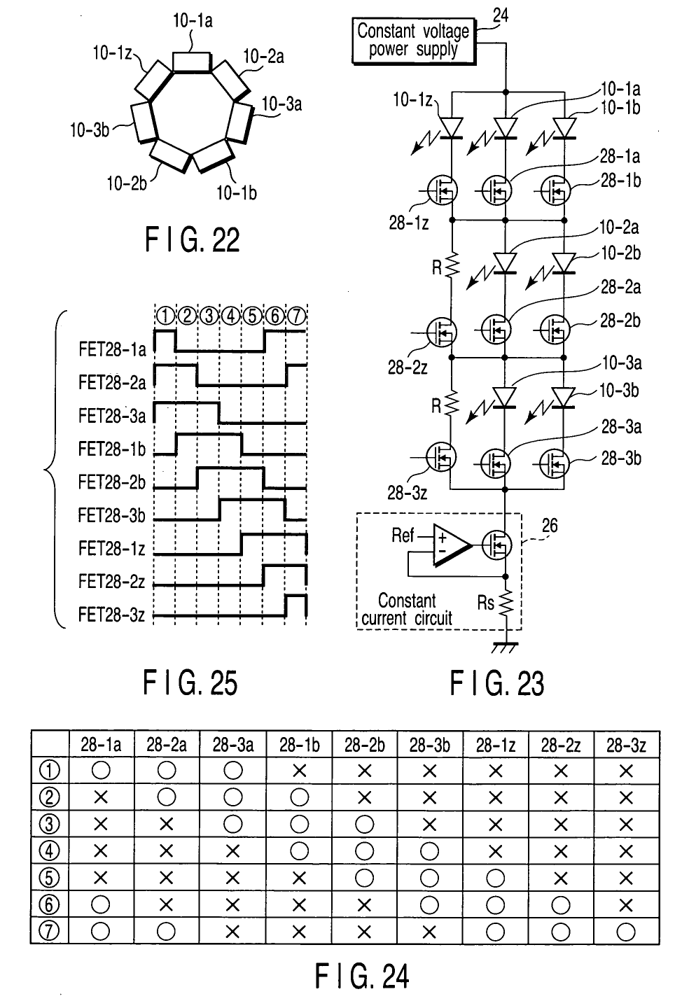

The first to third embodiments correspond to an example where the number of LEDs 10 is an integral multiple of the number of LEDs which are simultaneously turned on. However, when the number of LEDs 10 is not an integral multiple, e.g., when seven LEDs 10-1a, 10-2a, 10-3a, 10-1b, 10-2b, 10-3b and 10-1z are arranged on a circumference as shown in FIG. 22, unit circuits comprising the LED 10 and the FET 28 cannot be arranged in a matrix form like the first or second embodiment.

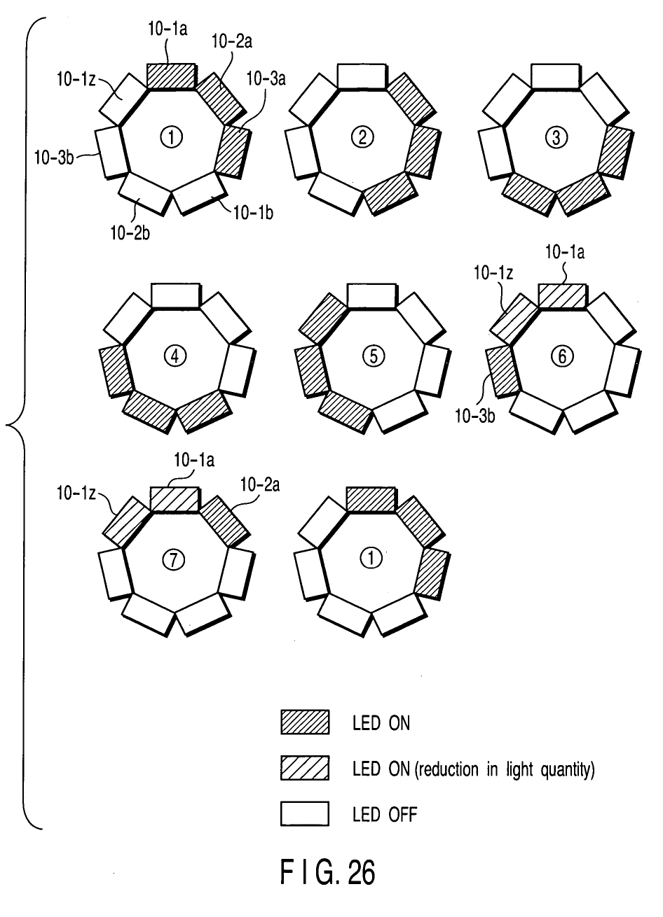

Thus, as shown in FIG. 23, dummy unit circuits, whose number is insufficient to be an integral multiple of the number of LEDs which are simultaneously turned on, i.e., two in this example, each of which is formed by using a resistance R in place of the LED 10 are utilized to configure a matrix arrangement. When such a circuit configuration is adopted, such LED lighting as shown in FIG. 26 can be obtained by performing such an FET control as shown in FIGS. 24 and 25. Here, in states shown in \mathring{6} and \mathring{7}, since the LED 10-1a and the LED 10-1z are connected in parallel, light quantities of the LEDs 10-1a and 10-1z are reduced as shown in FIG. 26. Therefore, in periods shown in \mathring{6} and \mathring{7}, a current value of the constant current circuit 26 may be set to a double value.

Furthermore, when the number of LEDs 10 is not an integral multiple of the number of LEDs which simultaneously emit light, it is possible to adopt a circuit configuration in which the LEDs whose number is an integral multiple may be used to form a matrix and the remaining LEDs are connected in parallel. That is, the plurality of unit circuits are connected in parallel to form a block, and such blocks are further connected in series. At this time, however, the number of unit circuits in each block may not be the same.

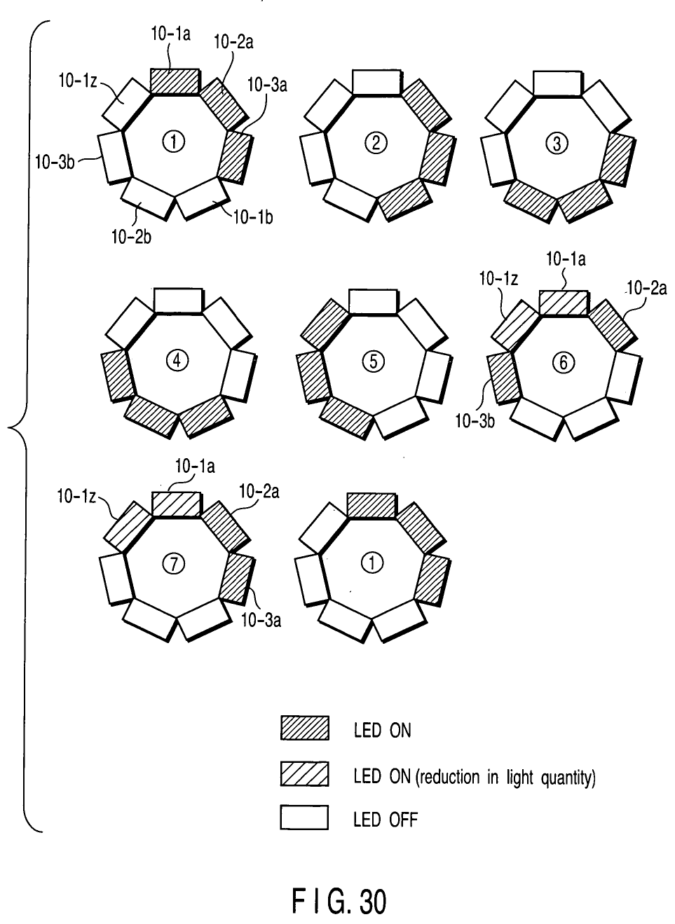

When such a circuit configuration is adopted, such LED lighting as shown in FIG. 30 can be obtained by performing such an FET control as shown in FIGS. 28 and 29. It is to be noted that light quantities of the LEDs 10-1a and 10-1z are reduced in a state where the LEDs 10-1a and 10-1z are connected in parallel like the circuit shown in FIG. 23. Thus, in states shown in and \mathring{7}, a combination of the LED 10-1a and the LED 10-1z is regarded as one LED, and lighting is performed with respect to three LEDs as the predetermined number of LEDs, which are the deemed LED and two other LEDs 10-3b and 10-2a or 10-2a and 10-3a.

### Fifth Embodiment

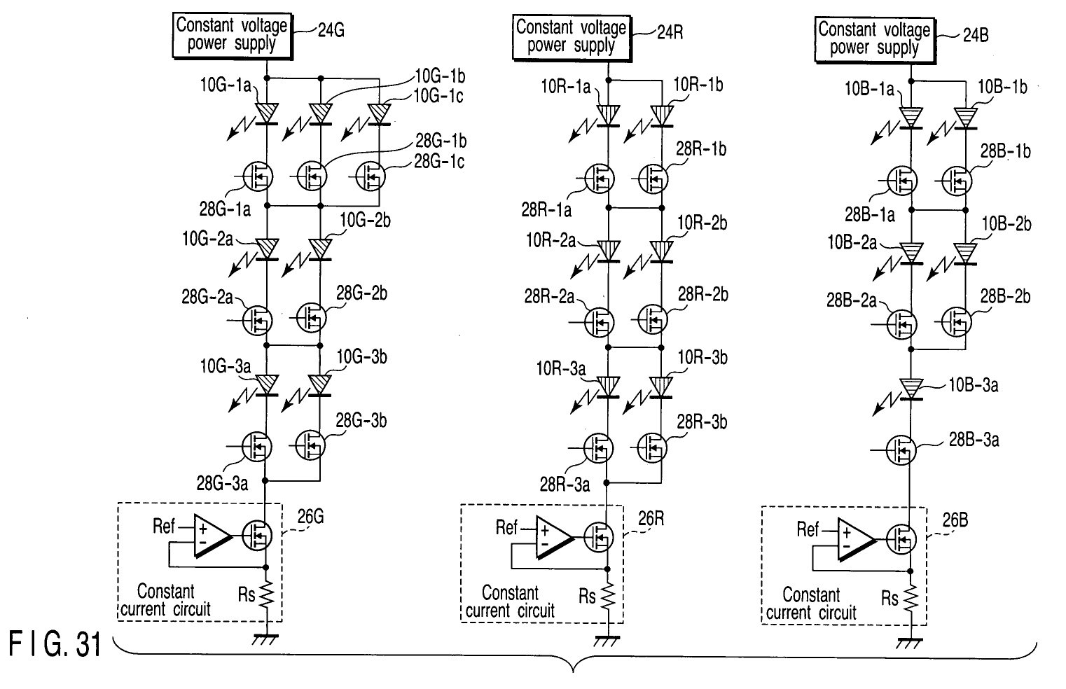

In the third embodiment, the description has been given as to the LED array in which the reflection type display element (e.g., a DMD) using a mirror for a pixel is used as a space modulation element. FIG. 31 is a view showing a configuration of an LED drive portion when a drive circuit is used for each color LED as a modification of the third embodiment.

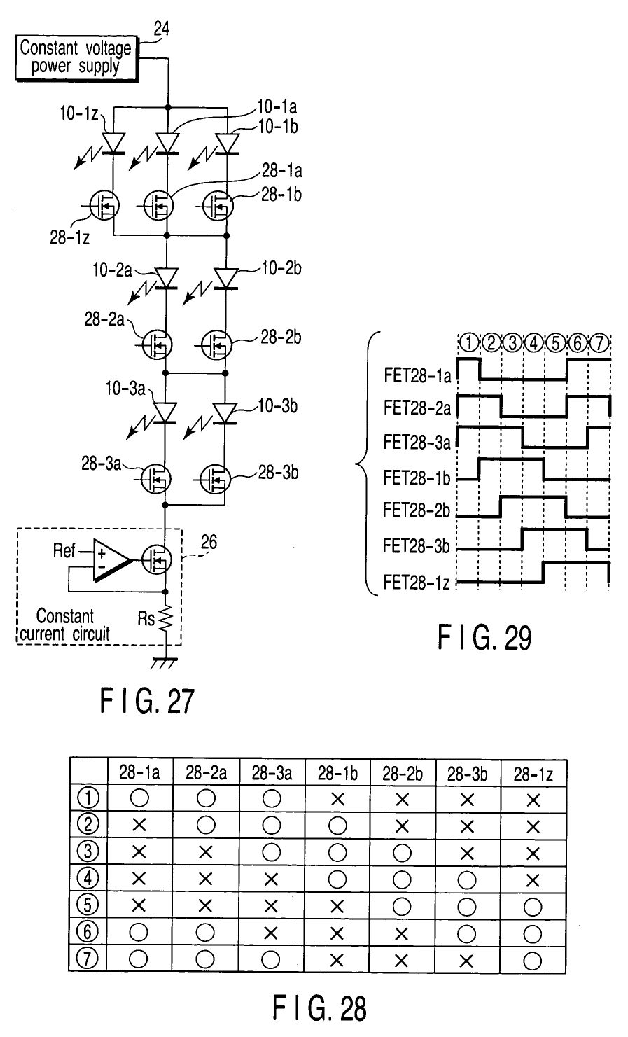

That is, the number of green LEDs is not an integral multiple of the number of the LEDs which simultaneously emit light, and hence green LEDs 10G-1a, 10G-2a, 10G-3a, 10G-1b, 10G-2b, 10G-3b and 10G-1c and corresponding FETs 28G-1a, 28G-2a, 28G-3a, 28G-1b, 28G-2b, 28G-3b and 28G-1c are connected between the constant voltage power supply 24G and the constant current circuit 26G like FIG. 27 described in conjunction with the fourth embodiment. Since the number of red LEDs is an integral multiple of the number of LEDs which are simultaneously turned on, red LEDs 10R-1a, 10R-2a, 10R-3a, 10R-1b, 10R-2b and 10R-3b and corresponding FETs 28R-1a, 28R-2a, 28R-3a, 28R-1b, 28R-2b and 28R-3b are connected between the constant voltage power supply 24R and the constant current circuit 26R like FIG. 5 described in conjunction with the first embodiment. Moreover, since the number of blue LEDs is not an integral multiple of the number of LEDs which are simultaneously turned on, blue LEDs 10B-1a, 10B-2a, 10B-3a, 10B-1b and 10B-2b and corresponding FETs 28B-1a, 28B-2a, 28B-3a, 28B-1b and 28B-2b are connected between the constant voltage power supply 24B and the constant current circuit 28B like FIG. 27 described in conjunction with the fourth embodiment.

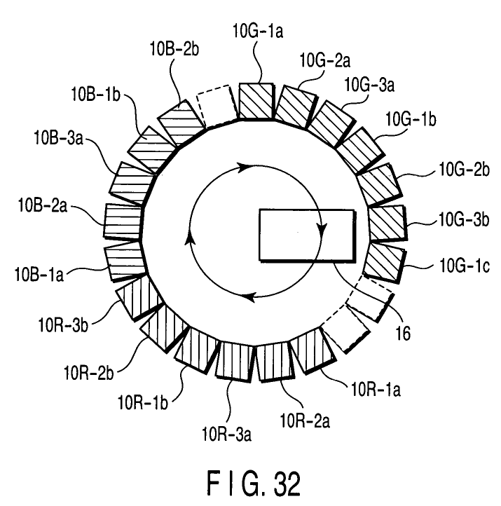

Such a circuit configuration corresponds to the example in which the seven green LEDs 10G-1a, 10G-2a, 10B-3a, 10B-1b, 10G-2b, 10G-3b and 10G-1c, the six red LEDs 10R-1a, 10R-2a, 10R-3a, 10R-1b, 10R-2b and 10R-3b and the five blue LEDs 10B-1a, 10B-2a, 10B-3a, 10B-1b and 10B-2b are arranged on a circumference as shown in FIG. 32. It is to be noted that a gap corresponding to two LEDs is formed between the green LED 10G-1c and the red LED 10R-1a, the red LED 10R-3b and the blue LED 10B-1a are adjacent to each other and a gap corresponding to one LED is formed between the blue LED 10B-2b and the green LED 10G-1a so that the LEDs of the respective colors are arranged as shown in FIG. 32.

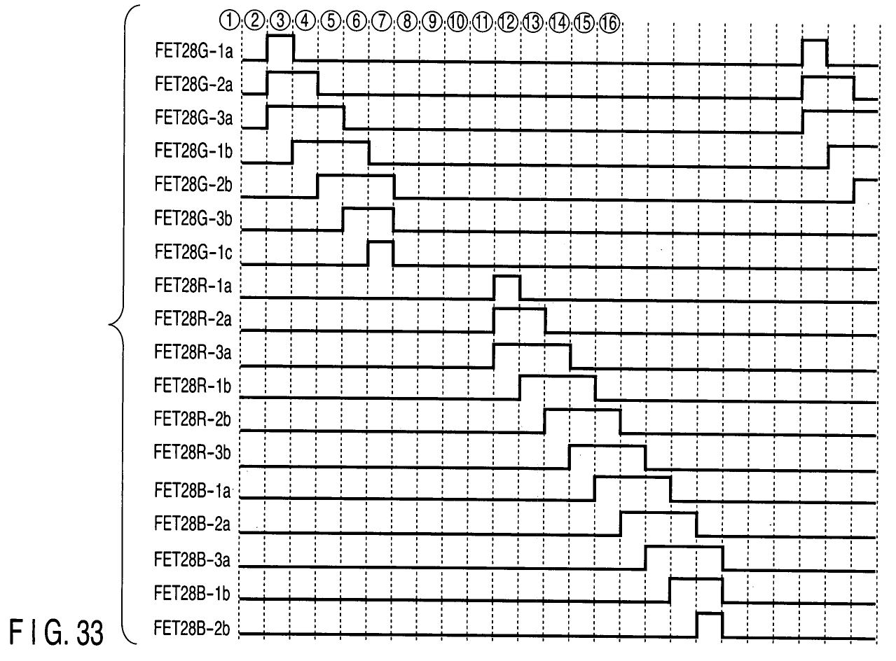

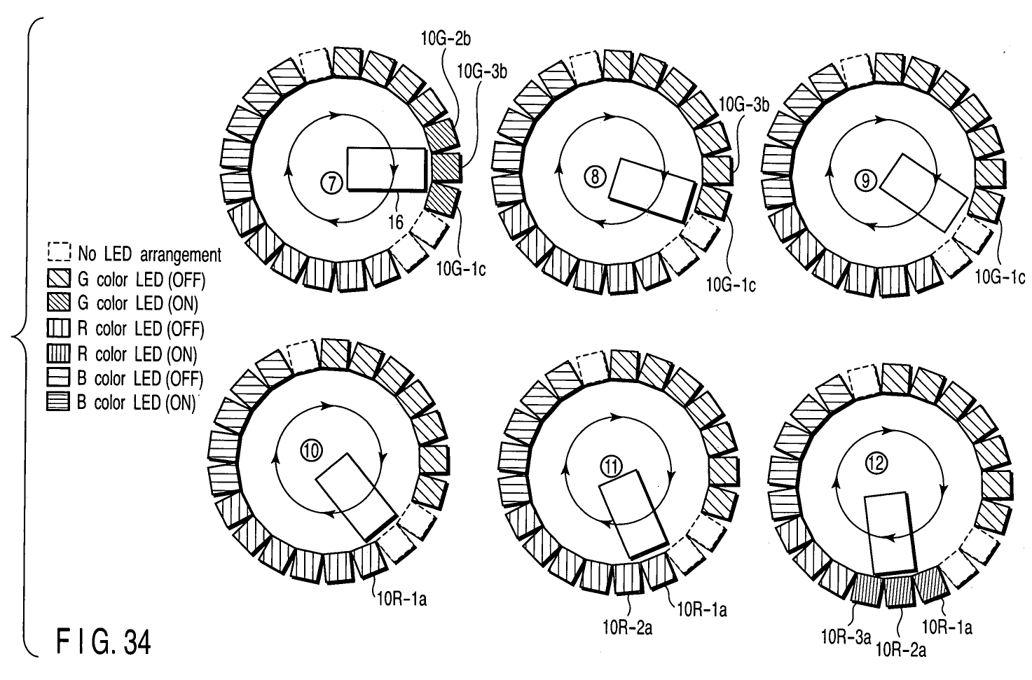

When such a circuit configuration is adopted, such LED lighting states as shown in FIG. 34 can be obtained by effecting such an FET control as shown in FIG. 33. It is to be noted that FIG. 34 shows LED lighting states and a position of the parallel rod 16 in the L-shaped light leading rod 12 with timings of \mathring{7} to \mathring{12} shown in FIG. 33.

When the number of the LEDs of each color is not an integral multiple of the number of the LEDs which are simultaneously turned on, there is a period in which light emission of the LEDs cannot be obtained like \mathring{8} to \mathring{11}. The influence on a projected light can be suppressed as much as possible by setting this period in the vicinity of blanking of switching of the respective colors of the space modulation element.

Although the present invention has been described based on the embodiments, the present invention is not restricted to the foregoing embodiments, and various modifications or applications can be effected within the scope of the present invention. For example, the number of the LEDs which are simultaneously turned on is not restricted three, and it may be any number. Additionally, the LEDs at positions where the LEDs face with each other on the circumference may be caused to emit light by using a T-shaped light leading rod in place of the L-shaped light leading rod 12. Further, although the FETs are used as the switching members, transistors may be used if the number of the LEDs is an integral multiple of the number of the LEDs which are simultaneously turned on. Furthermore, when the image projection apparatus based on the illumination apparatus according to the present invention is applied to a configuration part which projects an image in a color copying machine, a color printer, a rewritable electronic paper recording device and others, image forming means which is effective since its color adjustment is easy can be obtained.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. An illumination apparatus comprising:
a constant current power supply configured to be capable of supplying a constant current;
a plurality of unit circuits each of which includes at least a switching member which is able to shut off a current supplied from the constant current power supply, the plurality of unit circuits being electrically connected to the constant current power supply in a matrix form; and
a control portion configured to control the plurality of switching members,
wherein a predetermined number of unit circuits in the plurality of unit circuits further have at least one LED which is connected with the switching member in series in each current path which is set when the control portion controls the plurality of switching members.

2. The apparatus according to claim 1, wherein the constant current power supply includes:
a constant voltage power supply configured to be capable of supplying a constant voltage; and
a constant current circuit configured to make a current flowing through each current path constant by using the constant voltage power supply.

3. The apparatus according to claim 1, wherein a total number of the LEDs is an integral multiple of the number of LEDs which are simultaneously turned on when the control portion controls the switching members.

4. The apparatus according to claim 1, wherein all of the plurality of unit circuits have the same number of LEDs.

5. An illumination apparatus comprising:
a constant current power supply configured to be capable of supplying a constant current;
a plurality of unit circuits each of which includes at least a switching member which is able to shut off a current supplied from the constant current power supply, the plurality of unit circuits forming each block when electrically connected in parallel with respect to the constant current power supply, and the plurality of blocks obtained by connecting the plurality of unit circuits in parallel being electrically connected in series; and
a control portion configured to control the plurality of switching members,
wherein a predetermined number of unit circuits in the plurality of units circuits further have at least one LED which is connected with the switching member in series in each current path which is set when the control portion controls the plurality of switching members.

6. The apparatus according to claim 5, wherein the constant current power supply includes:
a constant voltage power supply configured to be capable of supplying a constant voltage; and
a constant current circuit configured to make a current flowing through each current path constant by using the constant voltage power supply.

7. The apparatus according to claim 5, wherein the control portion controls in such a manner that a current constantly flows through the same number of unit circuits in regard to the respective blocks electrically connected in parallel in the plurality of unit circuits when controlling the plurality of switching members.

8. The apparatus according to claim 7, wherein the number of unit circuits through which a current flows is equal in the respective blocks.

9. The apparatus according to claim 5, wherein a total number of the LEDs is an integral multiple of the number of LEDs which are simultaneously turned on when the control portion controls the switching members.

10. The apparatus according to claim 5, wherein the unit circuits included in the respective blocks include the same number of LEDs.

11. The apparatus according to claim 5, wherein all of the plurality of unit circuits have the same number of LEDs.

12. An image projection apparatus which projects an image according to image information input thereto, comprising:
an illumination apparatus including:
a constant current power supply configured to be capable of supplying a constant current;
a plurality of unit circuits each of which includes at least a switching member which is able to shut off a current supplied from the constant current power supply, the plurality of unit circuits being electrically connected to the constant current power supply in a matrix form; and
a control portion configured to control the plurality of switching members, a predetermined number of unit circuits in the plurality of unit circuits further having at least one LED which is connected with the switching member in series in each current path which is set when the control portion controls the plurality of switching members;
a space modulation element configured to perform modulation in accordance with the input image information;
an illumination optical system configured to illuminate the space modulation element by leading illumination light exiting from LEDs of the illumination apparatus; and
a projection optical system configured to project an image modulated by the space modulation element which is illuminated by the illumination optical system,
wherein a control portion of the illumination apparatus is configured to sequentially turn on the plurality of LEDs in time series, and
the illumination optical system has a light leading member which is synchronized with a lighting timing of the plurality of LEDs and relatively moves the plurality of LEDs, thereby leading illuminating light exiting from the LEDs which sequentially turned on in time series to the space modulation element.

13. The apparatus according to claim 12, wherein
the plurality of LEDs are arranged on a circumference, and
the illumination optical system is configured to swivel the light leading member around the center of the circumference on which the plurality of LEDs are arranged.

14. An image projection apparatus which projects an image according to image information input thereto, comprising:
an illumination apparatus including:
a constant current power supply configured to be capable of supplying a constant current;
a plurality of unit circuits each of which includes at least a switching member which is able to shut off a current supplied from the constant current power supply, the plurality of unit circuits forming each block when electrically connected in parallel with respect to the constant current power supply, and the plurality of blocks obtained by connecting the plurality of unit circuits in parallel being electrically connected in series; and
a control portion configured to control the plurality of switching members, a predetermined number of unit circuits in the plurality of units circuits further having at least one LED which is connected with the switching member in series in each current path which is set when the control portion controls the plurality of switching members;
a space modulation element configured to perform modulation in accordance with the input image information;
an illumination optical system configured to illuminate the space modulation element by leading illumination light exiting from LEDs of the illumination apparatus; and
a projection optical system configured to project an image modulated by the space modulation element which is illuminated by the illumination optical system,
wherein a control portion of the illumination apparatus is configured to sequentially turn on the plurality of LEDs in time series, and
the illumination optical system has a light leading member which is synchronized with a lighting timing of the plurality of LEDs and relatively moves the plurality of LEDs, thereby leading illuminating light exiting from the LEDs which sequentially turned on in time series to the space modulation element.

15. The apparatus according to claim 14, wherein
the plurality of LEDs are arranged on a circumference, and
the illumination optical system is configured to swivel the light leading member around the center of the circumference on which the plurality of LEDs are arranged.
